(19) United States
(12) Patent Application Publication
(10) Pub. No.: US 2025/0129450 A1
(43) Pub. Date: Apr. 24, 2025

(54) COMPOSITION, AND RESISTANCE HEATING ELEMENT

(71) Applicants: TOHOKU UNIVERSITY, Sendai-shi (JP); C&A Corporation, Sendai-shi (JP)

(72) Inventors: Rikito MURAKAMI, Sendai-shi (JP); Akira YOSHIKAWA, Sendai-shi (JP); Kei KAMADA, Sendai-shi (JP); Hiroaki YAMAGUCHI, Sendai-shi (JP); Shiika ITOI, Sendai-shi (JP); Yasuhiro SHOJI, Sendai-shi (JP)

(21) Appl. No.: 18/966,564

(22) Filed: Dec. 3, 2024

Related U.S. Application Data
(63) Continuation of application No. PCT/JP2023/038229, filed on Oct. 23, 2023.

(30) Foreign Application Priority Data
Aug. 25, 2022 (JP) 2022-134489

(51) Int. Cl. C22C 5/04; H05B 3/12; H05B 3/64

(52) U.S. Cl. CPC C22C 5/04; H05B 3/12; H05B 3/64

(57) ABSTRACT

This composition includes a Ru—Mo—W alloy having, in atomic %, a chemical composition including Mo: greater than 0% and 49% or less and W: greater than 0% and 45% or less, and the total content of Mo and W in the Ru—Mo—W alloy is greater than 30% and less than 50%.

### CROSS-REFERENCE TO RELATED APPLICATIONS

This application is a continuation of International Application No. PCT/JP2023/038229, filed on Oct. 23, 2023, which, in turn, claims priority to Japanese Patent Application No. 2022-134489, filed on Aug. 25, 2022, both of which are hereby incorporated herein by reference in their entireties for all purposes.

### TECHNICAL FIELD

The present invention relates to a composition and a resistance heating element.

### BACKGROUND ART

In a resistance heating type heating furnace, a resistance heating element is heated by applying a DC or AC current to the resistance heating element arranged in the furnace to generate heat in the heating furnace. As materials for resistance heating elements, carbon-based materials such as carbon (C) or silicon carbide (SiC), ceramic materials such as zirconia (ZrO₂) or lanthanum chromite (LaCrO₃), and metallic materials such as tungsten (W) or tantalum (Ta) are known.

The materials that can be used for resistance heating elements are mainly defined by an atmosphere required for heating and a target arrival temperature. For example, a deposition cell used for film formation such as film formation of organic electroluminescence (organic light emitting diode; OLED) or the like is a type of resistance heating furnace, and is generally used in high vacuum (about 10⁻⁵ Pa) inside the deposition cell. In vacuum deposition using a deposition cell, a crucible-shaped container is arranged in a region surrounded by a resistance heating element, the container is filled with the deposition raw material, and the resistance heating element is energized to heat the interior of the furnace and dissolve the deposition raw material.

Atoms or molecules that have been desorbed from the surface of the dissolved deposition raw material are imparted with directivity by the deposition cell and adhere to a substrate placed above the deposition cell, causing film formation to proceed. Here, since it is required that there is little desorption of substances other than the deposition raw material inside the deposition cell at the time of film formation, the resistance heating element that can be used in the deposition cell is limited to substances having low volatility at high temperature and in high vacuum. Conventionally, high melting point metals such as tungsten, molybdenum, or tantalum, which have a high melting point and low vapor pressure, have been used as the resistance heating element used under high temperature and high vacuum conditions. In particular, unlike tungsten and molybdenum, tantalum is widely commercialized because it is easily processed into the desired resistance heating element shape even at room temperature due to its high ductility and it has high design flexibility when used as a heater wire. Furthermore, tantalum has an advantage that it can be heated by a lower current in heating of the resistance heating element of the same volume because it has a higher electrical resistivity than tungsten or molybdenum, and therefore, the current source or electric wires can be downsized. Examples of such tantalum wires include a tantalum wire manufactured by Nilaco Corporation (refer to Non Patent Literature 1).

### CITATION LIST

### Patent Document

Patent Document 1: Japanese Unexamined Patent Application, First Publication No. 2005-281767

### Non Patent Document

Non Patent Literature 1: Internet <URL: https://shop.nilaco.jp/jp/estimates/?MENU=15&FROM=14&large_category=1&middle_category=%E3%82%BF%E3%83%B3%E3%82%BF%E3%83%AB&small_category=%E7%B7%9A>

Non Patent Literature 2: D. W. Rhys, The Fabrication and Properties of Ruthenium, J. Less-Common Met. 1 (1959) 269-291

Non Patent Literature 3: A. S. Darling, Some Properties and Applications of the Platinum-Group Metals, Int. Met. Rev. 18 (1973) 91-122

### TOTALMARY OF INVENTION

### Technical Problem

However, the durability temperature of a resistance heating element of tantalum is about 1,600° C., which is lower than the durability temperature of a resistance heating element of tungsten or molybdenum.

In addition, although electrical resistivity of metals generally increases with increasing temperature, the temperature dependence of the electrical resistivity of tantalum is larger than that of tungsten and molybdenum, and a slight change in temperature causes a change in electrical resistivity, making the temperature less controllable through voltage or current control. Furthermore, there is a problem that tantalum has a low electrical resistivity at low temperatures, which slows down the speed of temperature increase.

On the other hand, although the durability temperature of a resistance heating element of tungsten or molybdenum is higher than the durability temperature of a resistance heating element of tantalum, it is difficult to perform processing at room temperature, and therefore, it is necessary for tungsten or molybdenum to be heated for production of resistance heating elements, and there is a problem that manufacturing costs increase.

As described above, conventional metal resistance heating elements do not satisfy the following requirements of high durability, temperature dependence of electrical resistivity, and processability at room temperature in a well-balanced manner in commercial applications.

The present invention has been made in view of the above-described circumstances, and an object of the present invention is to provide a composition and a resistance heating element which satisfy each of the requirements of durability, electrical resistivity, temperature dependence of electrical resistivity, and processability at room temperature in a well-balanced manner.

### Solution to Problem

The gist of the present invention is as follows.

[1] A composition including: a Ru—Mo—W alloy having, in atomic %, a chemical composition including: Mo: greater than 0% and 49% or less and W: greater than 0% and 45% or less, wherein a total content of Mo and W is greater than 30% and less than 50%.

[2] In the composition according to [1] described above, the Ru—Mo—W alloy may have, in atomic %, the chemical composition including: Mo: 10% to 40% and W: 10% to 40%, and, the total content of Mo and W is 20% to 47%.

[3] In the composition according to [1] or [2] described above, the above-described Ru—Mo—W alloy may be in powder form or at least in paste form in which the Ru—Mo—W alloy is mixed with at least a solvent.

[4] The composition according to [1] or [2] described above may be a thin film.

[5] A resistance heating element including: a Ru—Mo—W alloy having, in atomic %, a chemical composition including: Mo: greater than 0% and 49% or less and W: greater than 0% and 45% or less, wherein a total content of Mo and W is less than 50%.

[6] In the resistance heating element according to [5] described above, the Ru—Mo—W alloy may have, in atomic %, the chemical composition including: Mo: 10% to 40% and W: 10% to 40%, and the total content of Mo and W is 20% to 47%.

[7] In the resistance heating element according to [5] or [6] described above, fracture elongation in a short axis tensile test at room temperature may be 5% or more.

[8] The resistance heating element according to [7] described above may have a linear or rod shape.

### Advantageous Effects of Invention

According to the present invention, it is possible to provide a composition and a resistance heating element which satisfy each of the requirements of durability, electrical resistivity, temperature dependence of electrical resistivity, and processability at room temperature in a well-balanced manner.

### BRIEF DESCRIPTION OF DRAWINGS

FIG. 1 A contour diagram showing electrical resistivity of a Ru—Mo—W alloy according to a chemical composition of the Ru—Mo—W alloy at 25° C. in Example 1.

FIG. 2 A graph showing a relationship between electrical resistivity and Mo and W contents relative to Ru in Example 1.

FIG. 3 A configuration diagram showing a configuration of a device for producing a resistance heating element that can be used for producing a resistance heating element according to one embodiment of the present invention.

FIG. 4 A configuration diagram showing a partial configuration of the device for producing a resistance heating element that can be used for producing the resistance heating element according to the same embodiment.

FIG. 5 A graph showing temperature dependence of electrical resistivity in Example 2.

FIG. 6 A graph showing temperature dependence of emissivity in Example 3.

FIG. 7 Images obtained through SEM-EBSD analysis for each sample in Example 4.

FIG. 8 Stress-strain curves for each sample in Example 4.

### DESCRIPTION OF EMBODIMENTS

Hereinafter, a composition and a resistance heating element according to embodiments of the present invention will be described with reference to the accompanying drawings. The present invention is not limited to the following embodiments.

### COMPOSITION

First, a composition according to one embodiment of the present invention will be described. The composition according to the present embodiment contains a Ru—Mo—W alloy having, in atomic %, a chemical composition including Mo: greater than 0% and 49% or less and W: greater than 0% and 45% or less, with the remainder being Ru and impurities, and the total content of Mo and W is greater than 30% and less than 50%. This will be described in detail below. In the following, unless otherwise specified in the explanation of the chemical composition, the notation “%” represents “atomic %.” In addition, the content of each element is the content relative to the Ru—Mo—W alloy.

### Ru—Mo—W Alloy

The Ru—Mo—W alloy in the composition according to the present embodiment contains ruthenium (Ru), tungsten (W), and molybdenum (Mo).

Ru is one of the platinum group elements having a high melting point (about 2334° C.), excellent chemical stability, and a low vapor pressure in a vacuum atmosphere. Ru has a hexagonal close-packed (HCP) structure, and other elements are solid-dissolved to form a Ru alloy. The Ru—Mo—W alloy in the composition according to the present embodiment is mainly composed of Ru.

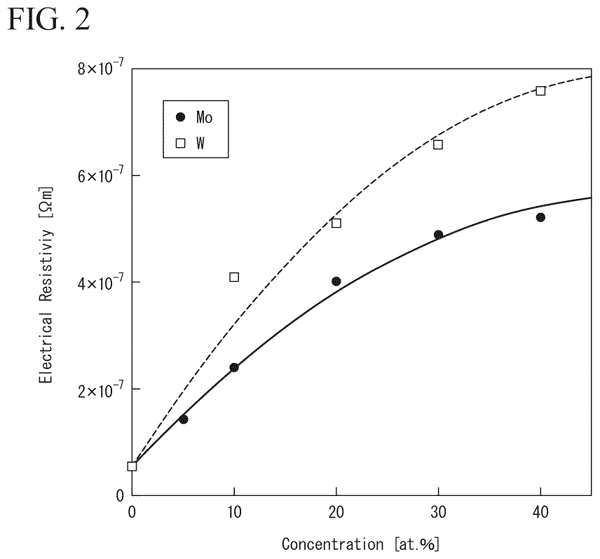

The electrical resistivity of Ru alone is as low as that of other pure metals, but the inclusion of alloying elements in Ru changes the electrical resistivity. The electrical resistivity increases as the amount of alloying elements contained in Ru increases. In detail, as shown in FIG. 2, where the electrical resistivity of the Ru alloy is plotted on the longitudinal axis and the content of alloying elements is plotted on the horizontal axis, the electrical resistivity increases as the content of Mo and W increases in a range where the content of Mo in a Ru—Mo alloy and the content of W in a Ru—W alloy each is 40 atomic % or less.

On the other hand, a stoichiometric compound is formed depending on alloying elements contained. For example, when a stoichiometric compound such as an intermetallic compound is formed, the metal structure of a Ru alloy becomes a dual phase structure, and the electrical resistivity of the Ru alloy varies depending on the form of the intermetallic compound that is a precipitation phase. Moreover, since it is also difficult to control the form of the intermetallic compound, it is difficult to control the electrical resistivity of the Ru alloy having the dual phase structure. Accordingly, metallic materials having the dual phase structure are not preferable as materials for resistance heating elements. However, this is not the case if the precipitation phase can be solubilized through heat treatment, and when alloying elements are solid-dissolved, the electrical resistivity is a value corresponding to the content of alloying elements. Therefore, from the viewpoint of increasing the electrical resistivity of the Ru alloy to increase the electrical resistivity of the composition, it is preferable to include elements having a higher solid solubility with respect to Ru and a higher degree of increase in electrical resistivity per unit concentration of the alloying elements. In addition, from the viewpoint of use at high temperatures, it is preferable that the Ru alloy have a high melting point. For example, it is desirable that the solidus temperature of the Ru alloy be higher than 1600° C. If the solidus temperature of the Ru alloy is higher than 1600° C., the Ru alloy can be used in a composition constituting a deposition cell in production of organic EL materials.

In addition, from the viewpoint of vapor pressure, the alloying elements preferably have vapor pressure lower than or equal to that of Ru.

### Mo: Greater Than 0% and 49% or Less

Mo has a high melting point (2623° C.), is chemically stable, and has a low vapor pressure. If the content of Mo is 49% or less, the melting point and electrical resistivity of the Ru—Mo—W alloy can be increased. Mo is solidly soluble at most about 40% with respect to Ru, and more content of Mo may form intermetallic compounds such as σ-phase. However, if the content of Mo is 49% or less, the σ phase will disappear upon heating. On the other hand, if the content of Mo is greater than 49%, a formed intermetallic compound cannot be made disappear by heat treatment, and the metal structure of the Ru—Mo—W alloy cannot be a single phase. Therefore, if the content of Mo is 49% or less, the melting point and electrical resistivity of the Ru—Mo—W alloy are increased, and the decrease in processability is suppressed. As a result, the electrical resistivity of the composition is increased and the decrease in processability is suppressed. Furthermore, if the content of Mo is 40% or less, production of intermetallic compounds is suppressed, and therefore high electrical resistivity can be maintained and excellent processability can be maintained. Therefore, the content of Mo is preferably 40% or less. On the other hand, although the lower limit of the content of Mo is not particularly limited, the content of Mo is preferably 10% or more to obtain an effect of increasing the melting point and electrical resistivity using Mo. The content of Mo is more preferably 13% or more.

### W: Greater Than 0% and 45% or Less

W has a high melting point (3442° C.), is chemically stable, and has a low vapor pressure. If the content of W is 45% or less, the melting point and electrical resistivity of the Ru—Mo—W alloy can be increased. W is solidly soluble at most about 40% with respect to Ru, and more amount of W may form intermetallic compounds such as σ-phase. However, if the content of W is 45% or less, the σ-phase will disappear by heating. On the other hand, if the content of W is greater than 45%, a formed intermetallic compound cannot be made disappear by heat treatment, and the metal structure of the Ru—Mo—W alloy cannot be a single phase. Therefore, if the content of W is 45% or less, the melting point and electrical resistivity of the composition are increased and the decrease in processability is suppressed. Furthermore, if the content of W is 40% or less, production of intermetallic compounds is suppressed, and therefore high electrical resistivity can be maintained and excellent processability can be maintained. Therefore, the content of W is preferably 40% or less. On the other hand, although the lower limit of the content of W is not particularly limited, the content of W is preferably 10% or more to obtain an effect of increasing the melting point and electrical resistivity using W. The content of W is more preferably 20% or more.

### Total Content of Mo and W Is Greater Than 30% and Less Than 50%

If the total content of Mo and W is less than 50%, intermetallic compounds of Mo or W are not produced or, even if they do, the amount thereof generated is very small or disappears upon heating. As a result, an effect of increasing the melting point and electrical resistivity using Mo and W is obtained and excellent processability is obtained. Therefore, the total content of Mo and W is less than 50%. The total content of Mo and W is preferably 47% or less. In addition, Mo and W can be solidly soluble by a total of 40% with respect to Ru. The total content of Mo and W is more preferably 40% or less to suppress the decrease in electrical resistivity due to the production of intermetallic compounds and the decrease in processability. The total content of Mo and W is 30% or more. The total content of Mo and W may be 33% or more.

### Ru—Mo—W Alloy

The Ru—Mo—W alloy in the composition may be contaminated with impurities from a production device and due to the conditions of a production process. Impurities are elements that are mixed into raw materials or mixed in a production step, and examples thereof include light elements such as H, Li, B, C, N, O, S, Na, and Mg, transition metals such as Fe, Ni, Cu, and Pb, rare earth elements, lanthanoids, and actinides. The content of impurities is preferably as low as possible, and may be 0%.

The Ru—Mo—W alloy may include elements having a melting point of 1500° C. or higher instead of a part of Ru. Since elements having a melting point of 1500° C. or higher have a relatively low vapor pressure, contamination of the interior of a furnace or a heated material due to the elements is suppressed. Examples of the elements having a melting point of 1500° C. or higher include Fe, Ni, V, Pt, Ir, Rh, Al, C, and N.

Platinum group elements such as Pt, Ir, and Rh have a high melting point, chemical stability, and high solubility with respect to Ru. Therefore, the Ru—Mo—W alloy may include platinum group elements.

In addition, typical elements such as Al, C, and N do not form compounds with Ru, and therefore, the electrical resistivity is maintained even if they are contained. Therefore, the Ru—Mo—W alloy may include typical elements.

As described above, elements having a melting point of 1500 degrees or higher are contained in a content range in which the solidus temperature of the Ru—Mo—W alloy is 1600° C. or higher.

The chemical composition of the Ru—Mo—W alloy is measured by the following method. In other words, wavelength-dispersive X-ray spectroscopy (WDS), energy dispersive X-ray spectroscopy (EDS), or the like can be used.

The composition according to the present embodiment may be composed of only the Ru—Mo—W alloy or may contain other constituent materials. The composition may be, for example, a paste. In detail, the composition according to the present embodiment may be a mixture of a powdered Ru—Mo—W alloy and at least a solvent. The particle diameter of the powdered Ru—Mo—W alloy may be of a size so that the powdered Ru—Mo—W alloy can be mixed with a solvent to form a paste-like composition. It is sufficient as long as the solvent is one, in which a resin is dissolved in an organic solvent, and is generally used to produce a paste containing metal powder.

The above-described paste-like composition may contain a binder for adjusting the performance from the viewpoints of dispersibility, viscosity, and the like.

The above-described mixture may further contain fine particles of an insulating material. Fine particles of an insulating material may be well-known materials, for example at least any of glass or an inorganic oxide. The content of an insulating material is not particularly limited, and may be any content, for example, 0.01 volume % or more, 0.1 volume % or more, or 1 volume % or more, and 99 volume % or less.

In addition, the composition according to the present embodiment may be in a thin film shape or may be a laminated film.

So far, the composition according to one embodiment of the present invention has been described.

### RESISTANCE HEATING ELEMENT

Subsequently, a resistance heating element according to one embodiment of the present invention will be described. A resistance heating element according to the present embodiment includes a Ru—Mo—W alloy having, in atomic %, a chemical composition including Mo: greater than 0% and 49% or less and W: greater than 0% and 45% or less, in which the total content of Mo and W is greater than 0% and less than 50%. The total content thereof is more preferably 10% or more and less than 50% and still more preferably 30% or more and less than 50%.

### Shape

The shape of the resistance heating element according to the present embodiment is not particularly limited and can be various shapes such as a linear shape, a rod shape, a plate shape, a bulk shape, and shapes obtained by appropriately processing those shapes. Since the shape of the resistance heating element can be linear in a production method using the micro-pulling-down method described below, it is preferably linear. Here, the linear shape refers to a shape extending in one direction with a diameter or a circle-equivalent diameter of 3 mm or less, and the rod shape refers to a shape extending in one direction with a diameter or a circle-equivalent diameter of greater than 50 mm.

### Metal Structure

Existing metallic resistance heating elements are polycrystalline because they are molded through machining processing such as forging and wire drawing. Such a metallic resistance heating element (hereinafter, the metallic resistance heating element is sometimes simply referred to as a metal resistance heating element) undergoes recrystallization during heat cycles, resulting in change in electrical resistivity and mechanical strength over time. As a result, the application conditions of currents and voltages for raising the temperature to an arbitrary level may change. In addition, the mechanical strength may be reduced and the resistance heating element may be deformed, resulting in unexpected contact or disconnection with surrounding members. In addition, during use of metal resistance heating elements, recrystallization or crystal grain growth often results in the formation of nodal structures. Even such nodal structures can degrade electrical or mechanical properties, sometimes leading to disconnection.

### Fracture Elongation

The resistance heating element according to the present embodiment preferably has an fracture elongation of 5% or more, more preferably 70% or more, and still more preferably 80% or more, in a short axis tensile test at room temperature. The minor axis tensile test is performed in accordance with JIS Z2241:2011 or ASTM A370. However, when a test specimen conforming to the standard cannot be obtained from a resistance heating element, a test specimen for which the proportion of the distance between gauge points to the maximum value in the width direction between the gauge points is 3 or more is used.

When the resistance heating element according to the present embodiment is a wire material, the diameter thereof is not particularly limited, but can be, for example, 0.1 mm to 3 mm. However, this diameter is merely an example, and various diameters can be adopted. In the micro-pulling-down method described below, the diameter can be set to, for example, 2 mm or less.

So far, the resistance heating element according to the embodiment of the present invention has been described.

### PRODUCTION METHOD

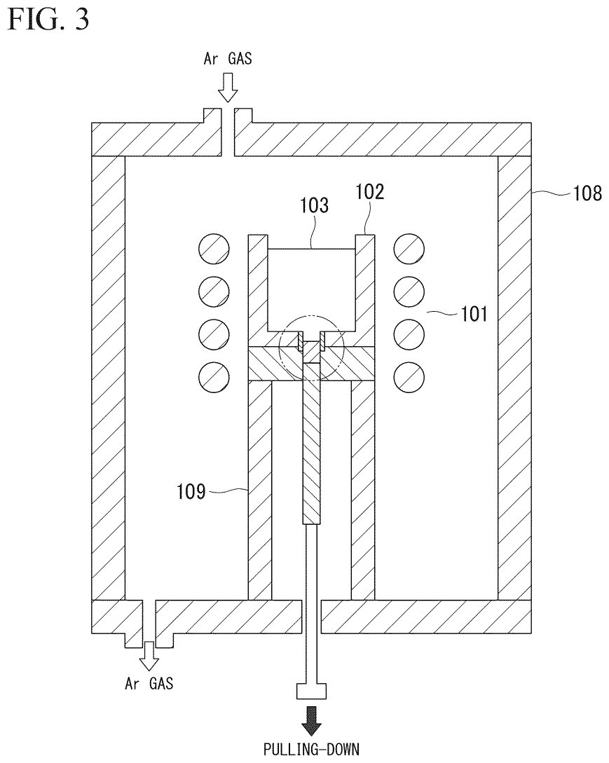

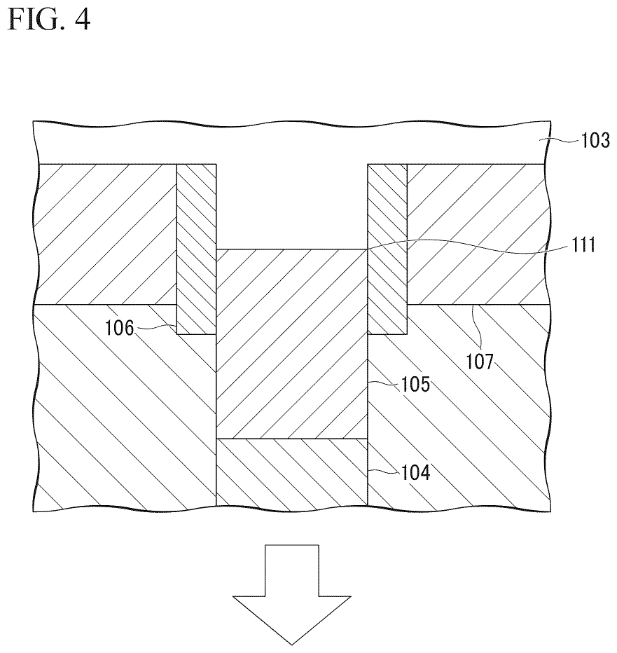

Methods for producing the above-described composition and resistance heating element are not particularly limited, and the production can be performed through, for example, the following method. In the following, a method for producing a wire material of a resistance heating element will be described as an example. The micro-pulling-down method (hereinafter referred to as a μ-PD method) can be applied to the wire material of the resistance heating element. In the μ-PD method, as shown in FIGS. 3 and 4, a molten metal 103 used as a raw material is housed in a crucible 102 which is made heatable using a high frequency induction coil 101, and a metal (wire material) 105 solidified through a growing crystal 104 is pulled down while passing through a nozzle 106 for crystal growth. The nozzle 106 is provided in a bottom portion 107 of the crucible 102. The crucible 102 is supported and fixed on a crucible stand 109 inside a treatment chamber 108. FIG. 4 shows an enlarged view of the inside of the dotted line of FIG. 3.

Since the resistance heating element according to the present embodiment has a high melting point as described above, a material that is difficult to dissolve and volatilize at high temperatures is used as a constituent material of the crucible 102 in the method for producing a wire material based on the μ-PD method. Specifically, ceramics such as magnesia, zirconia, and alumina, and carbon (graphite) are used as constituent materials of the crucible 102.

The nozzle 106 provided in the bottom portion 107 of the crucible 102 has both a function of cooling and solidifying the molten metal 103 passing through the bottom portion 107 and a function of constraining and molding the metal (wire material) 105 to be solidified as a tool (die). The constituent material of the nozzle 106 is preferably formed of a material that is difficult to dissolve and volatilize at high temperatures, as is the case with the crucible 102. Since friction with the solidified metal occurs in the inner wall of the nozzle 106, it is preferable that the inner wall surface of the nozzle 106 be smooth.

Although the length of the nozzle 106 is not particularly limited, it is preferably 3 to 30 mm to solidify the molten metal 103 in the nozzle 106 and obtain a wire material with a desired diameter. If the length of the nozzle 106 is too short, the solidification of the molten metal 103 in the nozzle 106 is insufficient, and when the wire material 105 with insufficient solidification is discharged from the nozzle 106, the solidification of the wire material 105 is completed after the constraint by the nozzle 106 is released, and therefore the wire material 105 may expand and become thicker in its wire diameter. On the other hand, if the length of the nozzle 106 is too long, the distance by which the wire material solidified in the nozzle 106 moves in the nozzle 106 increases, and the resistance of pulling down the wire material 105 increases. As a result, wear or damage to the nozzle 106 may occur, making it difficult to control the shape and size of the wire material.

To produce a wire material with a desired shape and diameter, it is important to control the state of the molten metal 103 and the wire material 105 in the nozzle 106. In detail, it is preferable that the position of a solid-liquid interface 111 be near the center of the nozzle 106 in the longitudinal direction. If the position of the solid-liquid interface 111 is on the upper side (side of the crucible 102), the distance by which the wire material solidified in the nozzle 106 moves in the nozzle 106 increases, and the resistance of pulling down the wire material 105 increases. As a result, wear or damage to the nozzle 106 may occur, making it difficult to control the shape and size of the wire material. On the other hand, if the solid-liquid interface 111 is located on the lower side (the outlet side of the nozzle 106), the solidification of the molten metal 103 in the nozzle 106 is insufficient, and when the wire material 105 with insufficient solidification is discharged from the nozzle 106, the solidification of the wire material 105 is completed after the constraint by the nozzle 106 is released, and therefore the wire material 105 may expand and become thicker in its wire diameter. The position of the solid-liquid interface 111 is controlled by appropriately adjusting the pulling down rate. The pulling down rate is preferably 0.5 to 200 mm/min. The pulling down rate is adjusted using a winding device (not shown in the drawings) by changing the winding rate of the wire material 105 discharged from the nozzle 106.

The wire material 105 discharged from the nozzle 106 is preferably cooled slowly in a temperature range exceeding recrystallization temperature. Fine crystals may be produced when the wire material 105 is rapidly cooled in a temperature range exceeding the recrystallization temperature. A resistance heating element that has fine crystals may recrystallize as the number of times of use increases, and the electrical resistivity and mechanical strength may change. Therefore, to prevent the generation of fine crystals, it is preferable to cool the wire material 105 slowly in a temperature range exceeding the recrystallization temperature. At least, in the case of producing a resistance heating element having the chemical composition described above, it is preferable to cool it slowly in a temperature range exceeding 1200° C.

The temperature range below the recrystallization temperature is not particularly limited, but rapid cooling may be performed in a temperature range of 1000° C. or lower.

The adjustment of the cooling rate is not particularly limited and may be performed by, for example, linking an after heater (not shown in the drawings) made of a heat conducting material such as ceramics to the crucible 102 at the lower part of the crucible 102 and using heat of the crucible 102 (molten metal 103).

The treatment of the molten metal 103 using the crucible 102 and the pulling down of the wire material 105 are preferably carried out in an atmosphere of an inert gas to prevent oxidation. The inert gas may be, for example, nitrogen, argon, or helium.

The wire diameter of the wire material 105 after cooling may be adjusted through additional processing. However, when performing adjustment of the linear shape, it is preferable to process so as not to leave residual distortion. If the processing temperature is low or the processing rate is high, distortion may remain, and structural change may occur due to recrystallization at the time of use at high temperatures.

In the μ-PD method, since crystal growth is carried out while limiting the cross-sectional area to be minute using the nozzle 106, the number density of crystal grains having an orientation difference of 15° or more from adjacent crystal grains in the cross-section perpendicular to the longitudinal direction can be less than 200 pieces/mm². In addition, according to the μ-PD method, a wire material of a desired size can be obtained without subsequent processing or with less frequent processing.

The rod material of a resistance heating element can be produced through a well-known method, not limited to the μ-PD method. For example, a floating zone (FZ) method or a zone melting method may be applied. According to the floating zone method and the zone melting method, it is possible to produce a resistance heating element of a larger size compared to the μ-PD method.

The production of a Ru—Mo—W alloy powder constituting the composition is not particularly limited, but the Ru—Mo—W alloy powder can be produced by, for example, grinding a resistance heating element produced by the above-described method, through a well-known method. In addition, a well-known method for producing metal powder, such as an atomization method may be applied, for example.

A composition containing a Ru—Mo—W alloy powder may be produced using a solvent or by mixing a solvent with an insulating material powder through a well-known method.

In addition, a thin film-like composition may be produced through, for example, physical vapor deposition (PVD), chemical vapor deposition (CVD), arc ion plating (AIP), or the like.

So far, the composition and resistance heating element according to the embodiments of the present invention have been described. However, the technical scope of the present invention is not limited to only the embodiment, and various modifications can be made within the scope not departing from the gist of the present invention.

As will be described in further detail in the examples to be described below, the composition and resistance heating element according to the embodiments of the present invention have excellent durability, electrical resistivity, temperature dependence of electrical resistivity, and processability at room temperature. Therefore, the composition and resistance heating element according to the embodiments of the present invention can be applied to various heating devices. The composition and resistance heating element according to the embodiments of the present invention can be applied to, for example, firing furnaces used for, for example, firing ceramics, magnets, or capacitors, hot isostatic press (HIP) devices or hot pressing devices used for, for example, producing a sputtering target, diffusion bonding dissimilar materials, or the like, heat treatment furnaces used for, for example, removing internal defects of metals, single-crystal production devices used for, for example, growing single crystals, heaters used for, for example, heating substrates in film formation devices, or filaments or boats of deposition devices.

### EXAMPLES

Next, examples of the present invention will be described. However, the conditions in the examples merely show an example of conditions employed to confirm the feasibility and effect of the present invention, and the present invention is not limited to the conditions used in the following examples. The present invention can adopt various conditions as long as the gist of the present invention is not deviated and the object of the present invention is achieved.

### Example 1

The electrical resistivity was measured for each of a Ru—Mo alloy wire material made with multiple Mo contents, a Ru—W alloy wire material made with multiple W contents, and a Ru—Mo—W alloy wire material made with multiple Mo and W contents. In detail, wire materials of the Ru—Mo—W alloy, the Ru—Mo alloy, and the Ru—W alloy having different chemical compositions were prepared using the production device described using FIGS. 3 and 4 through a μ-PD method. In detail, a raw material metal was placed in a crucible made of zirconia (dimensions of a container being 40 mm×30 mm×50 mm). In addition, a growing crystal (ϕ0.8 mm seed crystal) was inserted from below a nozzle (dimensions: 1 mm inner diameter, 5 mm length) provided in the bottom portion of the crucible. In this state, the raw material was dissolved by high frequency induction heating using a high frequency induction coil.

After the molten metal of the raw material was formed in the crucible, the molten metal was pulled down at a pulling down rate of 100 mm/min to produce a wire material with a wire diameter of 1 mm and a length of 5,000 mm.

The chemical composition of each Ru—Mo—W alloy prepared was Ru_{0.60}MO_{0.10}W_{0.30}, Ru_{0.60}MO_{0.20}W_{0.20}, Ru_{0.70}MO_{0.10}W_{0.20}, Ru_{0.70}MO_{0.15}W_{0.15}, Ru_{0.70}MO_{0.20}W_{0.10}, and Ru_{0.90}MO_{0.05}W_{0.05}.

The electrical resistivity was measured at room temperature through a four-terminal method.

FIG. 2 shows a graph showing a relationship between the electrical resistivity and the Mo and W contents with respect to Ru. As shown in FIG. 2, it was found that the electrical resistivity increases as the content of Mo and W increases in ranges of the content of Mo in the Ru—Mo alloy and the content of W in the Ru—W alloy of 40 atomic % or less, respectively.

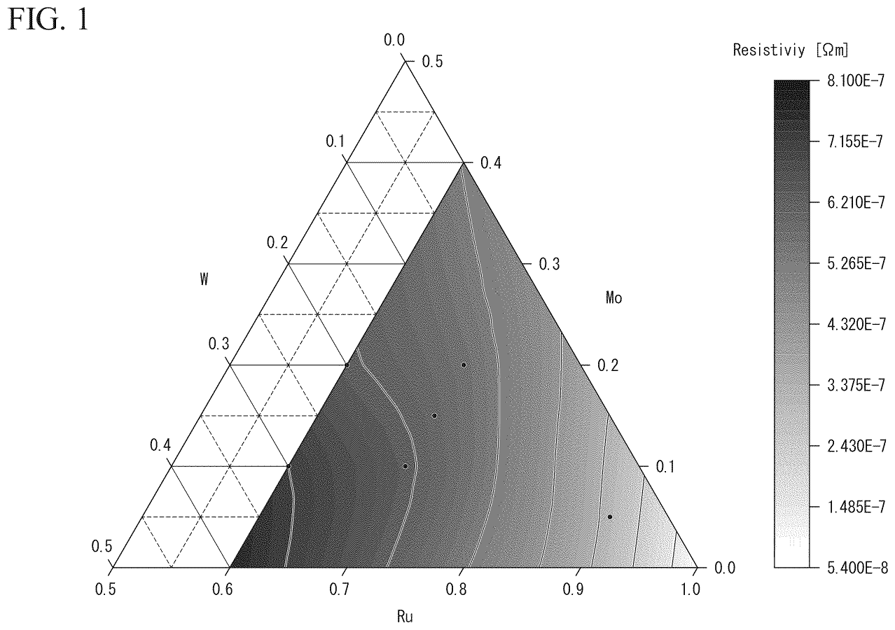

FIG. 1 shows the electrical resistivity of the Ru—Mo—W alloys at 25° C. FIG. 1 is a graph created using graph creation software Origin 2022 manufactured by Origin Lab Corporation based on actual measurement values. The plots in FIG. 1 are actual measurement values. As shown in FIG. 1, it was found that the electrical resistivity increases when Ru contains at least any of Mo or W.

### Example 2

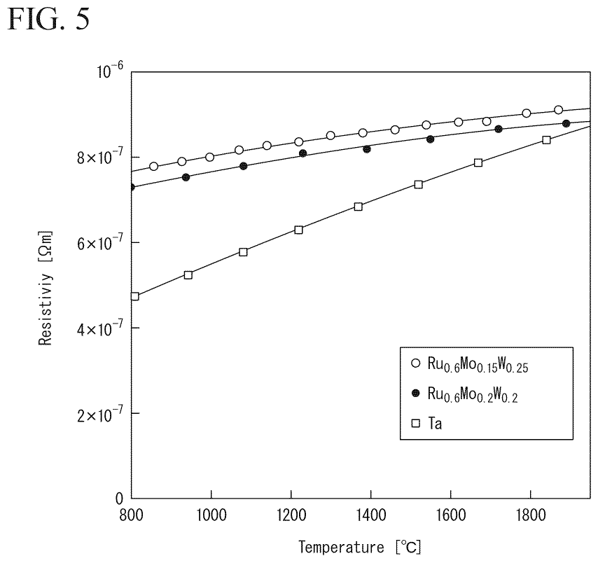

The chemical composition was changed and Ru—Mo—W alloy wire materials were prepared through the same method as in Example 1, and the temperature dependence of electrical resistivity was investigated. The chemical composition of the Ru—Mo—W alloys was Ru_{0.65}MO_{0.15}W_{0.25} and Ru_{0.60}MO_{0.20}W_{0.20}. The electrical resistivity of each sample at each temperature was measured through a pulse current heating method. FIG. 5 shows a graph showing temperature dependence of electrical resistivity. In addition, FIG. 5 shows temperature dependence of electrical resistivity of Ta as a comparative example.

In-furnace temperature control in a resistance heating furnace is generally realized by controlling applied voltages and currents to a resistance heating element so that the in-furnace temperature was actually measured using a temperature measuring instrument such as a thermocouple and the resulting in-furnace temperature is brought close to a target temperature. Therefore, it is desirable that the rate of change of the electrical resistivity with respect to the temperature change in the resistance heating element be lower. The electrical resistivity in metals is known to generally increase linearly with respect to temperature, but the proportional coefficient varies depending on metals. In addition, the temperature dependence of electrical resistivity is often nonlinear due to the effect of anharmonic vibrations of phonons.

As shown in FIG. 5, the electrical resistivity of the Ru—Mo—W alloys is about the same as the electrical resistivity of Ta in a temperature range exceeding 1800° C., but is larger than the electrical resistivity of Ta in a temperature range of 1800° C. or lower. Therefore, the heating efficiency of the Ru—Mo—W alloys becomes larger than that of Ta in the temperature range of 1800° C. or lower, and therefore, the temperature increase rate becomes faster. For example, the melting point of LiF, one of deposition raw materials that will become an organic EL is 848.2° C., and the usage temperature of the resistance heating element in the deposition of LiF is 1300° C. or lower. Therefore, the Ru—Mo—W alloys are also useful for the deposition of the organic EL raw materials such as LiF.

In addition, as shown in FIG. 5, the inclination of the graph of the electrical resistivity of the Ru—Mo—W alloys became smaller than the slope of the graph of the electrical resistivity of Ta. In other words, since the temperature dependence of electrical resistivity of the Ru—Mo—W alloys is smaller than the temperature dependence of electrical resistivity of Ta, the Ru—Mo—W alloys can realize higher controllability of the in-furnace temperature compared to that of Ta.

### Example 3

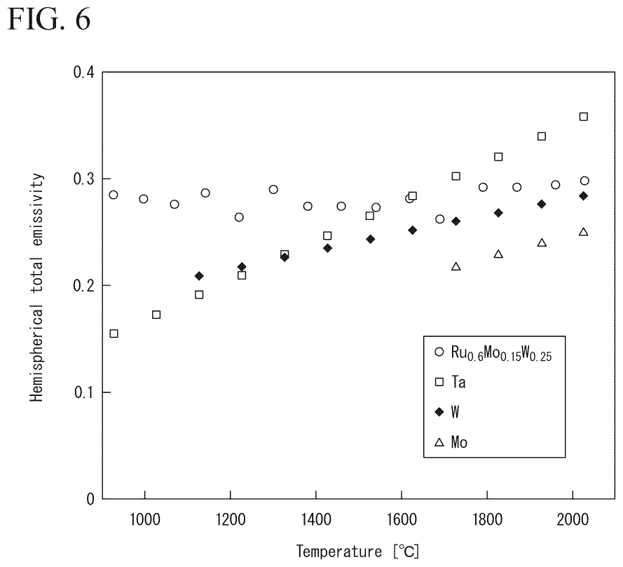

A Ru—Mo—W alloy was prepared through the same method as in Example 1, and the emissivity at each temperature was measured. The chemical composition of the Ru—Mo—W alloy was Ru_{0.65}MO_{0.15}W_{0.25}. The emissivity of each sample at each temperature was measured through a pulse current heating method. FIG. 6 shows a graph showing temperature dependence of emissivity. In addition, FIG. 6 shows temperature dependence of electrical resistivity of Ta, W, and Mo as comparative Examples.

Next, a case of using a resistance heating element as a radiant heating heater will be considered.

A resistance heating element generates light energy by radiation according to temperature. When a resistance heating element is used as a heating heater for deposition of an organic EL material, it is used in a high vacuum state. Therefore, radiation is a primary heat transfer mechanism. In that case, an object to be heated is heated by radiant energy I according to Stefan-Boltzmann law represented by Equation (1) below.

$$I = εσ {T}^{4} \qquad Equation ( 1 )$$

Here, in Equation (1) above, ε is an emissivity (Wm⁻²), σ is a Stefan-Boltzmann constant (Wm⁻²K⁻⁴), and T is a temperature (K). Since the intensity of the radiant energy emitted from the resistance heating element is proportional to the emissivity, the higher the emissivity, the better the heat transfer efficiency.

As shown in FIG. 6, the emissivity of the Ru—Mo—W alloy is equal to that of Ta, W, and Mo at 1800° C. or higher and higher than that of any of Ta, Mo, and W in a temperature range below 1800° C., and the difference increases as the temperature decreases. Therefore, since the current contotalption of the Ru—Mo—W alloy can be set to be less than the current contotalption of the Ta wire material in the temperature range below 1800° C., the power contotalption of the Ru—Mo—W alloy is less than the power contotalption of the Ta wire material in the temperature range below 1800° C. Furthermore, since the Ru—Mo—W alloy has a high heat transfer efficiency, resulting in a high response rate of the temperature rise due to application of voltages. Therefore, when the Ru—Mo—W alloy is used for deposition of an organic EL material, the time until the deposition rate stabilizes (stabilization time) is shorter than the stabilization time when the Ta wire material is used.

### Example 4

Ru—Mo—W alloy wire materials of Ru_{0.60}MO_{0.15}W_{0.25} (samples R-2 and R-3) and Ru_{0.60}MO_{0.20}W_{0.20} (sample R-4) and a wire material of Ru (R-1) were prepared through the same method as in Example 1, and the metal structures were observed and subjected to a room-temperature tensile test. The samples R-1, R-3, and R-4 were prepared through the same method as in Example 1, and seed crystals having different crystal grain numbers from each other were used for the preparation of the samples R-2 and R-3. In detail, a seed crystal with a large number of crystal grains was used for the sample R-2.

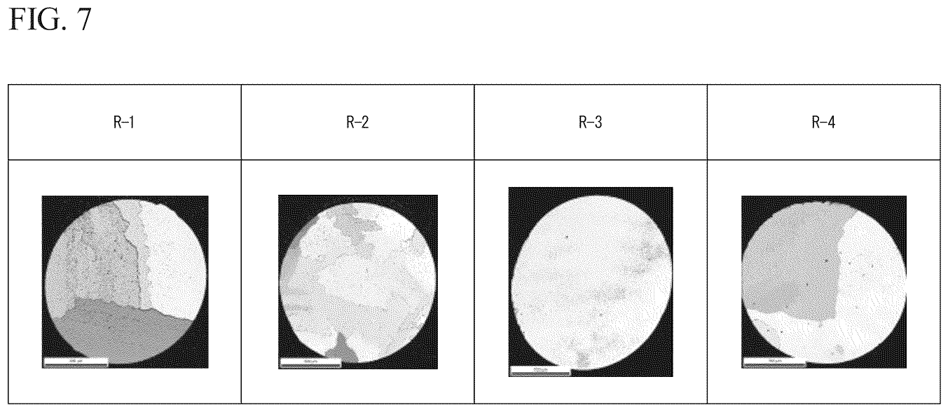

The metal structure of each sample of R-1 to R-4 was observed by an electron backscatter diffraction (EBSD) method. Specifically, the cross section perpendicular to the resistance heating element in the longitudinal direction was subjected to etching or ion milling treatment, the treated cross section was observed with a field of view at 30× to 300× magnification using a scanning electron microscope (SEM), and the crystal grains and the crystal orientation were specified using the electron backscatter diffraction method. In the EBSD method, the boundary between adjacent crystal grains with an azimuth difference exceeding 15° was defined as a large-angle grain boundary, and the particles separated by a large-angle grain boundary were defined as one crystal grain. FIG. 7 shows analysis results of the EBSD method.

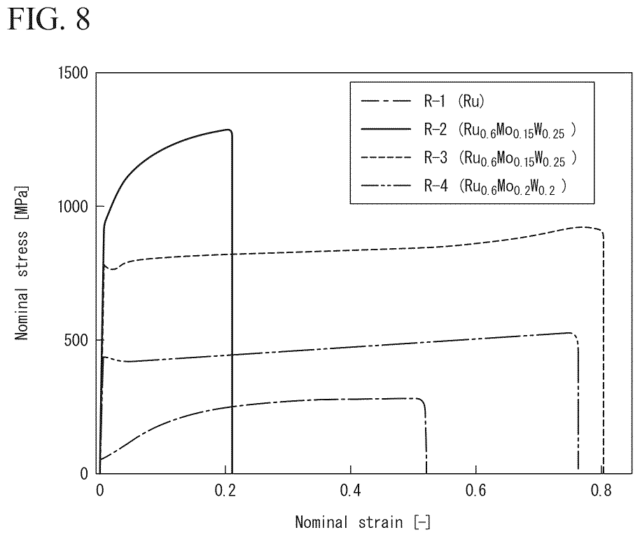

The room-temperature tensile test was performed on each of the prepared sample, and stress-strain curves were created. The room-temperature tensile test was performed in accordance with JIS Z2241:2011. FIG. 8 shows the stress-strain curves of the samples.

Polycrystal bodies of Ru and conventional Ru alloys are hard-to-process materials and are known to brittle-fracture due to intergranular fracture when attempted to be processed at room temperature. Therefore, it is considered extremely difficult or impossible to process the polycrystal bodies of Ru and conventional Ru alloys at room temperature. As a method to improve the ductility of Ru and Ru alloys, it is effective to reduce the grain boundary density by alloying and single crystallization or uni-directional solidification organization.

With regard to alloying, the addition of W to Ru does not improve ductility and causes brittle fracture at room temperature. On the other hand, Mo has an effect of imparting ductility to Ru.

With regard to reduction in the grain boundary density due to single crystallization or uni-directional solidification organization, reduction in Ru grain boundary density leads to great improvement in ductility. According to Non-Patent Literature 2 and 3, Ru produced through powder metallurgy has an fracture elongation of about 0% to 3% and shows little ductility. The grain boundary density in an element and an alloy can be generally reduced through a crystal growth method. Although conventional crystal growth methods such as the Czochralski method, the Bridgman method, a floating zone method, and a μ-PD method can be applied to methods applicable to Ru alloys, the μ-PD method is particularly desirable as a net-shape molding method for resistance heating elements because it enables precise shape control and continuous production of wires up to several tens of meters.

As shown in FIG. 7, the EBSD results showed that the samples R-1, R-3, and R-4 were polycrystals composed of single crystals or very few crystal grains, and R-2 was a polycrystal. In addition, as shown in FIG. 8, an fracture elongation of about 80% was obtained for R-1 and an fracture elongation of about 70% was obtained for R-2, which were larger than the fracture elongation for R-4. On the other hand, R-3 had a smaller fracture elongation than R-4. In addition, the fracture elongation for R-2 and R-3 was significantly larger than the fracture elongation of conventional Ru alloys of 0% to 3%. Therefore, the Ru—Mo—W alloy produced through the μ-PD method was found to exhibit large ductility.

### REFERENCE SIGNS LIST

101 High frequency induction coil
102 Crucible
103 Molten metal
104 Growing crystal
105 Solidified metal (wire material)
106 Nozzle
107 Bottom portion
108 Treatment chamber
109 Crucible stand
111 Solid-liquid interface

1. A specific alloy of a Ru—Mo—W alloy consisting essentially of Ru, Mo, and W, wherein:
in atomic percent,
i) a Mo's content of the Ru—Mo—W alloy is more than 0% and 49% or less;
ii) a W's content of the Ru—Mo—W alloy is more than 0% and 45% or less; and
iii) a total of the Mo's content and the W's content of the Ru—Mo—W alloy is more than 30% and less than 50%.

2. The specific alloy according to claim 1, the Ru—Mo—W alloy consisting essentially of Ru, Mo and W, wherein:
in atomic percent,
i) the Mo's content of the Ru—Mo—W alloy is 10% or more and 40% or less;
ii) the W's content of the Ru—Mo—W alloy is 10% or more and 40% or less; and
iii) the total of the Mo's content and the W's content of the Ru—Mo—W alloy is 20% or more and 47% or less.

3. The specific alloy according to claim 1,
wherein the Ru—Mo—W alloy is in powder form or at least in paste form in which the Ru—Mo—W alloy is mixed with at least a solvent.

4. The specific alloy according to claim 1, which contains the Ru—Mo—W alloy is a thin film.

5. A resistance heating element of an Ru—Mo—W alloy consisting essentially of Ru, Mo and W, wherein:
in atomic percent,
i) a Mo's content of the Ru—Mo—W alloy is more than 0% and 49% or less;
ii) a W's content of the Ru—Mo—W alloy is more than 0% and 45% or less; and
iii) a total of the Mo's content and the W's content of the Ru—Mo—W alloy is more than 30% and less than 50%, wherein
an fracture elongation of the Ru—Mo—W alloy is 5% or more.

6. The resistance heating element according to claim 5,
wherein the Ru—Mo—W alloy consisting essentially of Ru, Mo and W, wherein in atomic percent,
i) a Mo's content of the Ru—Mo—W alloy 10% or more and 40% or less;
ii) a W's content of the Ru—Mo—W alloy is 10% or more and 40% or less; and
iii) a total of the Mo's content and the W's content of the Ru—Mo—W alloy is 20% or more and 47% or less, wherein:
an fracture elongation of the Ru—Mo—W alloy is 5% or more.

7. The resistance heating element according to claim 5,
wherein the resistance heating element has a linear or rod shape.

8. A chemical composition of an Ru—Mo—W alloy consisting essentially of Ru, Mo and W, wherein:
in atomic percent,
i) a Mo's content of the Ru—Mo—W alloy is more than 0% and 49% or less;
ii) a W's content of the Ru—Mo—W alloy is more than 0% and 45% or less; and
iii) a total of the Mo's content and the W's content of the Ru—Mo—W alloy is more than 30% and less than 50%, and
the chemical composition further comprises an electrical insulator.

9. The chemical composition according to claim 8, the Ru—Mo—W alloy consisting essentially of Ru, Mo and W, wherein:
in atomic percent,
i) a Mo's content of the Ru—Mo—W alloy is more than 10% and 40% or less;
ii) a W's content of the Ru—Mo—W alloy is more than 10% and 40% or less; and
iii) a total of the Mo's content and the W's content of the Ru—Mo—W alloy is more than 20% and 47% or less.
